(19) United States
(12) Patent Application Publication
(10) Pub. No.: US 2010/0005181 A1
(43) Pub. Date: Jan. 7, 2010

(54) METHOD AND SYSTEM FOR CONTROLLING A TERMINAL ACCESS AND TERMINAL FOR CONTROLLING AN ACCESS

(75) Inventor: Yi ZHANG, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: CHENGDU HUAWEI SYMANTEC TECHNOLOGIES CO., LTD., Chengdu (CN)

(21) Appl. No.: 12/478,113

(22) Filed: Jun. 4, 2009

(30) Foreign Application Priority Data
Jul. 7, 2008 (CN) 200810127680.8
Feb. 13, 2009 (CN) PCT/CN2009/070427

(51) Int. Cl. G06F 15/173; H04L 29/06

(52) U.S. Cl. 709/229; 726/1

(57) ABSTRACT

A method and a system for controlling terminal access, and a terminal for controlling access are provided. The method includes: receiving a policy configuration sent by a server on a network side; modifying local setting according to the policy configuration; and controlling an access authority of the terminal according to the modified local setting. Thus, when terminal access control is needed for a terminal connected to the network, the policy configuration can be delivered to the agent of the terminal, so that the agent controls an access authority of the terminal according to the policy configuration. Thereby, the convenient and flexible separation of the pre-authentication domain and the post-authentication domain is realized for different terminals, so as to meet the requirements for access control of multiple terminals.

### CROSS-REFERENCE TO RELATED APPLICATIONS

This application claims priority to Chinese Patent Application No. 200810127680.8, filed Jul. 7, 2008, and International Patent Application No. PCT/CN2009/070427, filed Feb. 13, 2009, both of which are hereby incorporated by reference in their entirety.

### FIELD OF THE TECHNOLOGY

The present invention relates to the field of communication technology, and more particularly to a method and system for controlling terminal access, and a terminal for controlling access.

### BACKGROUND

In the field of terminal access control, a gateway is usually used to separate the pre-authentication domain and post-authentication domain to protect system resources. The pre-authentication domain refers to the domain which a terminal can access before passing the authentication. The system resources such as the authentication server, the patch server and the anti-virus server are usually arranged in the pre-authentication domain, so that the terminal can access these servers to realize security repair, so as to be authenticated and access the resources in the post-authentication domain. The post-authentication domain refers to the domain which the terminal can access after passing the authentication. The protected system resources are usually arranged in the post-authentication domain. The terminal can access the resources of the post-authentication domain only after being authorized. Therefore, it is desired to separate the pre-authentication domain and the post-authentication domain at a low cost.

In the conventional art, a method for implementing access control based on software is provided, for example address resolution protocol (ARP) spoofing. A user can access the network after the user passes the authentication, and a terminal that does not pass the authentication cannot access the network normally.

In the process of implementing the present invention, the inventor discovers that the following problems exist in the conventional art.

The method can only realize the switch function of access control, that is, the network access is denied before authentication, while all network resources can be accessed after the authentication is passed. However, different network resources exist in the network, when whether different network resources can be accessed needs to be determined according to the authorization rights of different users, the method in the conventional art cannot meet the demand.

### SUMMARY

Various embodiments of the present invention provide a method and a system for controlling terminal access, and a terminal for controlling access, so as to control access authorities of different accessed terminals.

An embodiment of the present invention provides a method for controlling terminal access. The method is as follows.

A policy configuration sent by a server on a network side is received, and the policy configuration is generated by the server on the network side according to an authorization range of a terminal identity after a terminal is authenticated.

Local setting is modified according to the policy configuration.

An access authority of the terminal is controlled according to the modified local setting.

An embodiment of the present invention further provides a system for controlling terminal access, including at least one terminal and a server.

The at least one terminal includes an agent, and the agent is adapted to receive a policy configuration sent by a server on a network side, and modify local setting according to the received policy configuration to control an access authority of the terminal.

The server is adapted to authenticate the terminal, generate the policy configuration according to an authorization range of a terminal identity, and send the policy configuration to the agent of the terminal.

An embodiment of the present invention further provides a terminal for controlling access, including a receiving unit, a configuring unit, and a controlling unit.

The receiving unit is adapted to receive a policy configuration sent by a server, the policy configuration being generated by the server on the network side according to an authorization range of a terminal identity after a terminal is authenticated.

The configuring unit is adapted to modify local setting according to the policy configuration received by the receiving unit.

The controlling unit is adapted to control an access authority of the terminal according to the local setting modified by the configuring unit.

Compared with the conventional art, the embodiments of the present invention have following advantages.

When terminal access control is needed for a terminal connected to a network, the policy configuration can be delivered to the agent of the terminal, so that the agent controls the access authority of the terminal according to the policy configuration. Thus, the convenient and flexible separation of the pre-authentication domain and the post-authentication domain is realized for different terminals, so as to meet the requirements for access control of multiple terminals.

### BRIEF DESCRIPTION OF THE DRAWINGS

The present invention will become more fully understood from the detailed description given herein below for illustration only, and thus are not limitative to the present invention, and wherein:

FIG. 1 is a flow chart of the method for controlling the terminal access according to an embodiment of the present invention;

FIG. 2 is a flow chart of the process for controlling the terminal access through the IPSec policy according to an embodiment of the present invention;

FIG. 3 is a schematic structural view of the system for controlling the terminal access according to an embodiment of the present invention;

FIG. 4 is a schematic structural view of the agent according to an embodiment of the present invention; and

FIG. 5 is a schematic structural view of the server according to an embodiment of the present invention.

### DETAILED DESCRIPTION

The technical solutions in the embodiments of the present invention will be described in detail as follows with reference to the accompanying drawings. Obviously, the embodiments described herein are only a part of exemplary embodiments of the present invention. Based on the embodiments given herein, persons of ordinary skill in the art can obtain all other embodiments without paying any creative effort, which shall fall within the protection scope of the present invention.

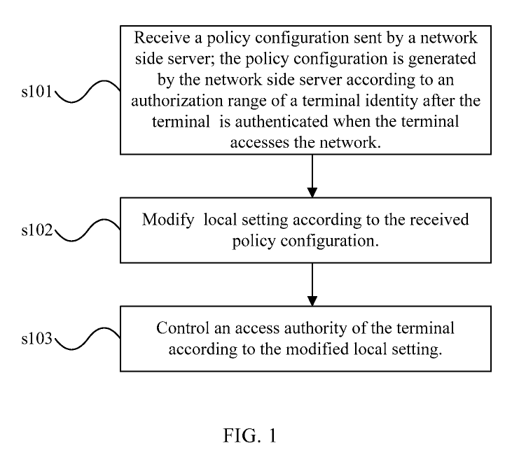

An embodiment of the present invention provides a method for controlling terminal access. As shown in FIG. 1, the method includes the following blocks.

Block s101: A policy configuration sent by a server on a network side is received; the policy configuration is generated by the network side according to an authorization range of a terminal identity after a terminal is authenticated when the terminal connects to a network.

Block s102: Local setting is modified according to the received policy configuration.

Block s103: An access authority of the terminal is controlled according to the modified local setting.

In detail, the terminal access control according to the embodiment of the present invention is implemented through an agent function on the terminal. The agent controls the domain which can be accessed by the terminal according to a control rule delivered by the server on the network side. Before the terminal passes authentication of an access authentication server, according to the default local setting preset on the agent, the terminal can access only the domain where the server on the network side is located, i.e., pre-authentication domain. After the terminal passes the authentication of the server on the network side, according to the authorization range of the terminal identity, the server on the network side delivers the corresponding policy configuration to the agent of the terminal, and the terminal can access the authorized service resources, i.e., authorized post-authentication domain, under the control of the agent.

By using the method for terminal access control according to the embodiment of the present invention, when terminal access control is needed for a terminal connected to the network, the policy configuration can be delivered to the agent of the terminal, so that the agent controls the access authority of the terminal according to the policy configuration. Thereby, the convenient and flexible separation of the pre-authentication domain and the post-authentication domain is realized for different terminals, so as to meet the requirements for access control of multiple terminals.

The embodiments of the present invention are further illustrated in the following through specific application scenarios.

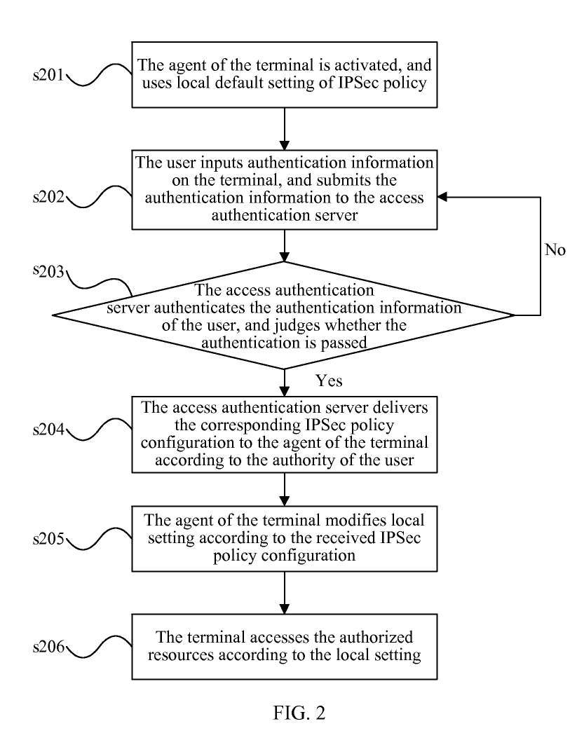

In the implementation of authorizing different accessed resources to different terminals, for example, when the server on the network side is the access authentication server, the control of terminal authorities can be realized by using the access authentication server to deliver Internet protocol security (IPSec) policies. The access authentication server implements the control of different access authorities by delivering different IPSec policies to different terminals. In detail, after the terminal passes the authentication, the access authentication server queries the authorization range of the terminal, obtains the predefined IPSec policy corresponding to the authorization range, and then delivers the obtained IPSec policy to the terminal; the terminal can access only the authorized resources on an IP layer according to the IPSec policy. The implementation process is as shown in FIG. 2, and includes the following blocks.

Block s201: The agent of the terminal is activated, and uses the local default setting of IPSec policy that allows the terminal to access only the pre-authentication domain where the access authentication server is located.

Block s202: The user inputs authentication information on the terminal, and submits the authentication information to the access authentication server.

Block s203: The access authentication server authenticates the authentication information of the user, if the authentication is not passed, return to block s202 and remind the user to perform re-authentication; if the authentication is passed, block s204 is performed.

Block s204: The access authentication server delivers the corresponding IPSec policy configuration to the agent of the terminal according to the authorization of the user.

For example, if the access authentication server needs to block all network communications from a terminal based on Windows Server 2003 or Windows XP to user datagram protocol (UDP) 1434 port on any other terminal, the access authentication server delivers the corresponding IPSec policy, assembles the policy into the following script at the terminal, and runs the script.

IPSeccmd.exe -w REG -p “Block UDP 1434 Filter” -r “Block Outbound UDP 1434 Rule” -f 0=*:1434:UDP -n BLOCK

In block s205, the agent of the terminal modifies the local setting according to the received IPSec policy configuration.

Taking the IPSec policy delivered by the access authentication server in block s204 for example, the agent generates a “Block UDP 1434 Filter” policy in “local security setting-->IP security policy” of the terminal. Through the policy, computers running SQL Server 2000 can be prevented from spreading “Slammer” worm effectively.

Block s206: The terminal accesses the authorized resources according to the local setting.

By using the method for terminal access control according to the embodiment of the present invention, when the terminal access control is needed for the terminal connected to the network, the policy configuration (such as the IPSec policy configuration) can be delivered to the agent of the terminal, so that the agent controls the access authority of the terminal according to the policy configuration. Thereby, the convenient and flexible separation of the pre-authentication domain and post-authentication domain is realized for different terminals, so as to meet the requirements for access control of multiple terminals.

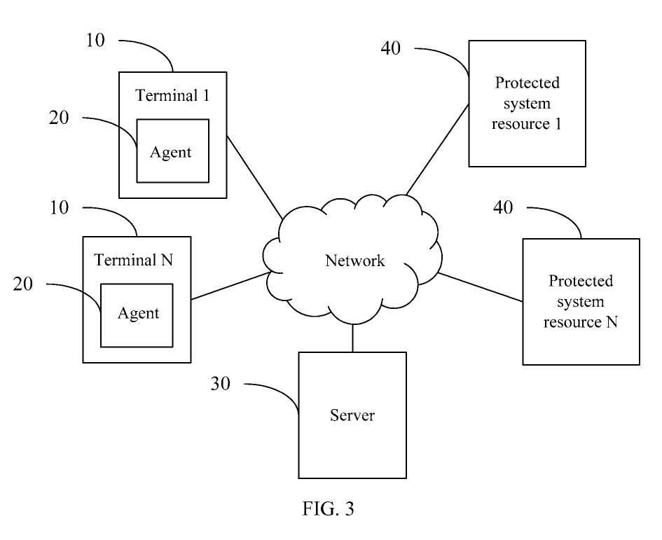

As shown in FIG. 3, the embodiment of the present invention further provides a system for controlling terminal access, including at least one terminal 10, a server 30 and protected system resources 40.

Each terminal 10 includes an agent 20. The agent 20 is adapted to receive a policy configuration sent by the server 30 on the network side, and modify local setting according to the received policy configuration to control an access authority of the terminal 10. The terminal 10 may be controlled by the agent 20 and access the protected system resources 40 in the range of access authority thereof.

The server 30 is adapted to authenticate the terminal 10 when the terminal 10 is connected to the network, generate the policy configuration according to an authorization range of a terminal identity of the terminal 10, and send the policy configuration to the agent 20 on the terminal 10, so as to control the access authority of the terminal 10 and enable the terminal 10 to access the protected system resources 40 in the range of access authority thereof.

The protected system resources 40 are adapted to provide the resources for the terminal 10 with the access authority to access.

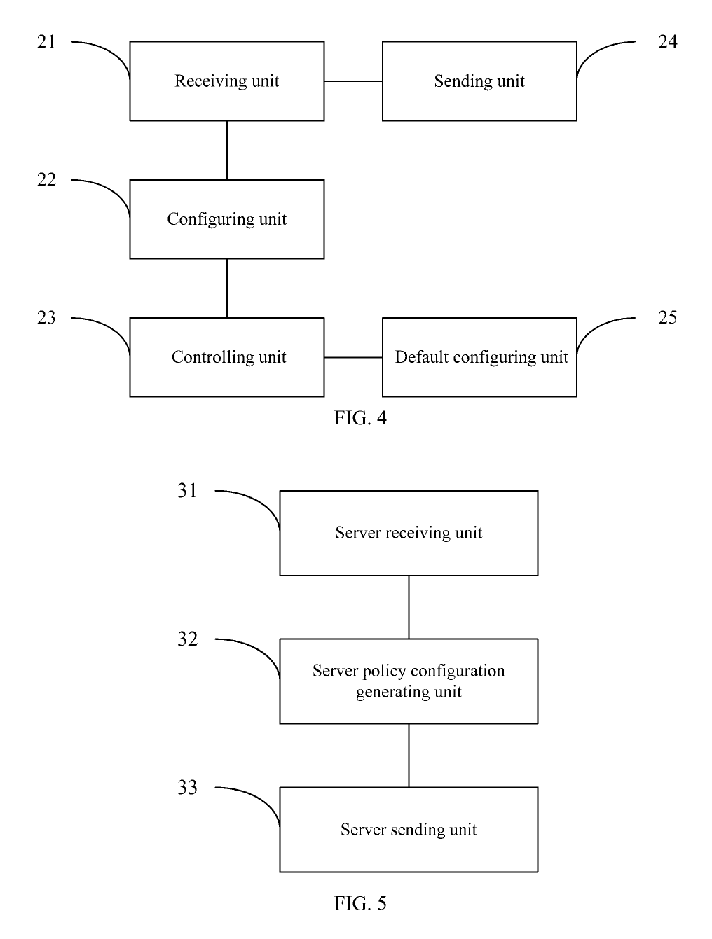

In detail, the structure of the agent 20 is as shown in FIG. 4, and includes a receiving unit 21, a configuring unit 22, and a controlling unit 23.

The receiving unit 21 is adapted to receive the policy configuration sent by the server 30; the policy configuration may be an IPSec policy configuration. The policy configuration is generated by the server 30 according to an authorization range of a terminal identity of the terminal 10 after the terminal 10 is authenticated when the terminal 10 connects to the network.

The configuring unit 22 is adapted to modify local setting according to the policy configuration received by the receiving unit 21.

The controlling unit 23 is adapted to control an access authority of the terminal 10 according to the local setting modified by the configuring unit 22.

In addition, the agent 20 further includes a sending unit 24 and a default configuring unit 25.

The sending unit 24 is adapted to send an authentication request of the terminal 10 to the server 30.

The default configuring unit 25 is adapted to provide a default local setting for the controlling unit 23 before the sending unit 24 sends the authentication request of the terminal 10 to the server 30, so as to control the access authority of the terminal 10.

In detail, the structure of the server 30 is as shown in FIG. 5, including a server receiving unit 31, a server policy configuration generating unit 32, and a server sending unit 33.

The server receiving unit 31 is adapted to receive the authentication request sent by the agent 20 on the terminal 10.

The server policy configuration generating unit 32 is adapted to generate the corresponding policy configuration according to the authorization range of the terminal identity when the server receiving unit 31 receives the authentication request. The policy configuration may be an IPSec policy configuration.

The server sending unit 33 is adapted to send the policy configuration generated by the server policy configuration generating unit 32 to the agent 20 on the terminal 10.

By way of using the system and device for controlling the terminal access according to the embodiments of the present invention, when terminal access control is needed for a terminal connected to the network, the policy configuration (such as an IPSec policy configuration) can be delivered to the agent of the terminal, so that the agent controls the access authority of the terminal according to the policy configuration. Thereby, the convenient and flexible separation of the pre-authentication domain and post-authentication domain is realized for different terminals, so as to meet the requirements for access control of multiple terminals.

It should be understood by persons of ordinary skill in the art that, the implementation of all or a part of the processes in the method of the embodiments may be completed by instructing related hardware with a computer program. The program may be stored in a computer readable storage media. In execution, the program may include the processes of the above embodiments of the method. The storage media may be a magnetic disk, an optical disk, a read-only memory (ROM), or a random access memory (RAM).

Some specific embodiments of the present invention are disclosed in the above; however, the present invention are not limited to the above embodiments, and all modifications that can be easily thought of by persons skilled in the art shall fall into the protection scope of the present invention.

Finally, it should be noted that the above embodiments are merely provided for describing the technical solutions of the present invention, but not intended to limit the present invention. It should be understood by those of ordinary skill in the art that although the present invention has been described in detail with reference to the foregoing embodiments, modifications or equivalent replacements can be made to the technical solutions described in the foregoing embodiments, as long as such modifications or equivalent replacements do not cause the modified technical solutions to depart from the spirit and scope of the present invention.

What is claimed is:

1. A method for controlling terminal access, comprising:
receiving a policy configuration sent by a server on a network side, the policy configuration being generated by the server on the network side according to an authorization range of a terminal identity after a terminal is authenticated;
modifying a local setting according to the policy configuration; and
controlling an access authority of the terminal according to the modified local setting.

2. The method according to claim 1, before receiving the policy configuration sent by the server on the network side, the method further comprising:
sending an authentication request to the server on the network side.

3. The method according to claim 2, before sending an authentication request to the server on the network side, the method further comprising:
controlling the access authority of the terminal according to a default local setting.

4. The method according to claim 1, wherein the policy configuration sent by the server on the network side is generated according to the authorization range of the terminal identity.

5. The method according to claim 1, wherein the policy configuration is an Internet protocol security configuration.

6. The method according to claim 4, wherein the policy configuration is an Internet protocol security configuration.

7. A system for controlling terminal access, comprising:
a terminal adapted to receive a policy configuration sent by a server on a network side and modify a local setting according to the received policy configuration to control an access authority of the terminal; and
a server adapted to authenticate the terminal, generate the policy configuration according to an authorization range of a terminal identity and send the policy configuration to the terminal.

8. The system according to claim 7, wherein the terminal comprises:
a receiving unit adapted to receive the policy configuration sent by the server;
a configuring unit adapted to modify the local setting according to the policy configuration received by the receiving unit; and
a controlling unit adapted to control the access authority of the terminal according to the local setting set by the configuring unit.

9. The system according to claim 8, wherein the agent further comprises:
a sending unit adapted to send an authentication request of the terminal to the server; and
a default configuring unit adapted to provide a default local setting for the controlling unit to the server to control the access authority of the terminal before the sending unit sends the authentication request of the terminal.

10. The system according to claim 7, wherein the server comprises:
a server receiving unit adapted to receive the authentication request sent by the terminal;
a server policy configuration generating unit adapted to generate a corresponding policy configuration according to the authorization range of the terminal identity when the server receiving unit receives the authentication request; and
a server sending unit adapted to send the policy configuration generated by the server policy configuration generating unit to the terminal.

11. A terminal for controlling access, comprising:
a receiving unit adapted to receive a policy configuration sent by a server, the policy configuration being generated by a server on a network side according to an authorization range of a terminal identity after the terminal is authenticated;
a configuring unit adapted to modify a local setting according to the policy configuration received by the receiving unit; and
a controlling unit adapted to control an access authority of the terminal according to the local setting modified by the configuring unit.

12. The terminal according to claim 11, further comprising:
a sending unit adapted to send an authentication request of the terminal to the server; and
a default configuring unit adapted to provide a default local setting for the controlling unit to control the access authority of the terminal before the sending unit sends the authentication request of the terminal to the server.
